(19) United States
(12) Patent Application Publication
(10) Pub. No.: US 2010/0049338 A1
(43) Pub. Date: Feb. 25, 2010

(54) Air conditioner system with optimizer

(75) Inventor: Warren Schmitt, Las Vegas, NV (US)

Correspondence Address: John F. Vodopia, 54 Cherry Lane, Huntington, NY, 11743, US

(73) Assignee: Airfantastic, Inc.

(21) Appl. No.: 12/229,191

(22) Filed: Aug. 20, 2008

(51) Int. Cl. G05B 13/02; F28D 15/00; F28F 13/00; G05B 15/00; G05D 16/00

(52) U.S. Cl. 700/28; 165/104.19; 165/108; 700/275; 700/301

(57) ABSTRACT

Described is an air conditioning system optimizer for optimizing operation of a compressor of the air conditioning system. The optimizer modifies a temperature and pressure of refrigeration fluid or gas operating for cooling purposes in the compressor and condenser coil within a compressor housing using enhanced water cooling by and with an exhaust air flow generated by a compressor housing fan. The optimizer includes a primary water cooling system that applies cooling water to the compressor through the compressor housing in a primary water cooling cycle and a secondary evaporative cooling system that operates with the primary water cooling system to capture once-used water in evaporative cooling elements and direct the once-used water to compressor housing locations susceptible to the exhaust air flow during normal air conditioning system operation in a secondary evaporative cooling cycle, controlling temperature and refrigeration fluid pressure to minimize compressor load in an energy-conserving and water-conserving manner.

### BACKGROUND OF THE INVENTION

Commercial and residential air conditioning (A/C) systems are refrigeration systems that lower the temperature of an enclosed space by removing heat from that space and transferring it elsewhere. Air conditioning systems cool or refrigerate by implementing what is referred to in the art as vapor cycle refrigeration, and in particular, vapor compression refrigeration. Vapor compression refrigeration is one of the many refrigeration cycles available for use in air conditioning systems comprising large public buildings, private residences, hotels, hospitals, theaters, restaurants and automobiles.

Vapor-compression refrigeration systems use a circulating liquid, i.e., a refrigerant, as a medium to absorb and remove heat from the space to be cooled, and subsequently carry the heat elsewhere. FIG. 1 depicts a typical, single-stage vapor-compression air conditioning system (2). The known air conditioning system includes four major system components: a gas (refrigerant) compressor (4), a condenser (6), an expansion valve (8), also called a throttle valve, and an evaporator (10). The evaporator includes an evaporator fan (e; 11) to push air over the evaporator, cooling it. The compressor (4)/condenser (6) includes a compressor fan (c; 7) to push air over the condenser (6) drawing heat away from the high-pressure side refrigerant flow in cooperation with the expansion valve. The condenser will typically include heat dispersion fins (not shown in FIG. 1), to distribute heat from the condenser coil so that it might better be removed with the air flowing to exhaust heat. A thermostat and controller (not shown in FIG. 1) controls the air conditioning system, or cooling operation. When the ambient temperate exceeds a preset value, the thermostat signals the controller, which signals other parts of the air conditioning system to go to work and cool the environment served by the evaporator.

When operational, circulating refrigerant enters the compressor (4) in the thermodynamic state known as a saturated vapor and is compressed to a higher pressure, resulting in a higher temperature as well. The hot, compressed vapor is then in the thermodynamic state known as a superheated vapor and it is at a temperature and pressure at which it can be condensed with typically available cooling water or cooling air. The hot vapor is routed through the condenser (6), where it is cooled and condensed into a liquid by flowing through the condenser coils, or tubes, with water or air flowing across the coil or tubes. This is where the circulating refrigerant rejects heat from the system and the rejected heat is carried away by either the water or the air. For that matter, such conventional air conditioning systems are referred to as air-to-air systems in view of the fact that the compressor/condenser coil is cooled via a fan (c; 7).

The condensed liquid refrigerant, in the thermodynamic state known as a saturated liquid, is next routed through the expansion valve (8), where it undergoes an abrupt reduction in pressure. The pressure reduction results in the adiabatic flash evaporation of a part of the liquid refrigerant, which lowers the temperature of the liquid and/or vapor refrigerant mixture to where it is colder than the temperature of the enclosed space to be refrigerated. The cold mixture is then routed through the coil or tubes in the evaporator (10). The fan (e; 11) circulates the warm air in the space to be cooled across the evaporator coil or tubes carrying the cool refrigerant liquid and/or vapor mixture. To complete the refrigeration cycle, the refrigerant vapor from the evaporator is again a saturated vapor and is routed back into the compressor/condenser.

Haloalkane (Freon) is a trade name for a family of haloalkane refrigerants, manufactured by DuPont Corporation and other companies. These refrigerants were commonly used due to their superior stability and safety properties: they were not flammable nor obviously toxic as were the fluids they replaced. Newer and more environmentally-safe refrigerants include HCFCs, such as Chlorodifluoromethane (R-22), sometimes referred to as Freon 22, which is used in most known residential air conditioning systems manufactured today. These known residential air conditioning systems typically are designed to operate efficiently up to around 95 degrees Fahrenheit. That is, up to about 95 degrees Fahrenheit, known residential air conditioning units and systems deliver close to their specified rated cooling output.

As the surrounding temperature of an air conditioning system rises, the compressor must work harder to accommodate the heat load of the area to be cooled. The compressor and condenser also must remove the heat in the cabinet or housing, in which the compressor and condenser are housed. For that matter, a rise in ambient environment operating temperature will generally see an increased power load, or increased current draw by the compressor. And as is known, long term operation at increased ambient temperatures causes increased bearing wear, and premature compressor failure.

To overcome this, large commercial air conditioning systems are known to utilize water to enhance fan cooling of the compressor/condenser coil, and coil fins. Water distribution is typically implemented as a spray directly onto the compressor coil and coil fins from spray bars, nozzles, water sheeting means, etc., as known to the skilled artisan. The cooling water is applied to be evaporated, and not for reuse. While an evaporator arranged in a cooling space (attic) will typically include a pan to catch water condensed from the evaporator, it is only to prevent water damage. Most outdoor compressors will not include a pan for collecting water because the compressor/condenser is normally out of doors, where water damage is unlikely. In addition, because the condenser coil and coil fins generally are at an operating temperature that is hotter that the ambient temperature, they are not likely to collect condensated water during normal compressor air cooling cycle operation. While cooling a compressor/condenser by applying water is known in large commercial air conditioning systems, such known further cooling methods are impractical in compressor/condenser housings found in smaller residential air conditioning units. Moreover, such known further cooling methods and operation are not known to be water and energy conservent.

The additional power requirements required to pump cooling water to distribution ports is known to minimize any energy efficiency realized by the water's primary cooling effect. The additional cooling derived by applying water to a commercial compressor/condenser configuration is known to stabilize electrical load and maintain an even internal refrigerant pressure. For that matter, while any applied water that is not evaporated could be collected, filtered, pressurized and re-circulated, this requires additional power, and much water is lost to evaporation from collecting means without much system operational benefit. This is particularly so in hot, or dry environments.

The economic and environmental cost for using sprayed or vaporized water to support compressor cooling in known commercial systems can be quite high, particularly in environments where water is limited. The environmental cost renders known water applications impractical in conventional residential air conditioning system designs. Moreover, applying such technology to residential air conditioning systems also would require substantial modification to known system designs, as well as increased electrical power used to implement the water vaporization. And while vaporization, and energy cost for same could be decreased somewhat by using a misting system, in lieu of a vaporization system, applying a fine mist requires a substantial amount of liquid water over time, with its inherent financial and environmental shortcomings, as already mentioned.

### SUMMARY OF THE INVENTION

The present invention provides an air conditioning system with an optimizer that overcomes the shortcomings of known compressor cooling applications used within residential air conditioning systems.

The present invention advantageously optimizes compressor operation by cooling the compressor, condenser (coil) and refrigerant circulating therein, and any heat removing means such as fins with cooling water in a first cooling cycle. The optimizer captures and reuses once-used water from the primary water-cooling cycle in a secondary cooling cycle, reusing the once-used water with reliance on the normal operation of a compressor, or compressor-housing fan, leveraging the electrical energy consumed by the fan.

In one embodiment, the invention comprises an air conditioning system with optimizer that provides enhanced water cooling of intake air utilized to cool a compressor/condenser, including air in a compressor housing that houses the compressor/condenser and provides for an inlet for air therein to be used to exhaust heat from the compressor housing in cooperation with the optimizer. A preferably large fan mounted in the top of the housing draws air into, up and out of the housing for intended cooling operation. The optimizer is constructed with a water-based compressor/condenser primary cooling system (primary water cooling system), and a secondary evaporative cooling system that collects and redistributes water used once by the primary water cooling system. The secondary evaporative cooling system provides the recycled, once-used water for capture by air moved by the compressor fan (referred to interchangeably as the housing fan) in a secondary optimizer evaporative cooling cycle in cooperation with the primary water cooling system.

The secondary evaporative cooling system provides a collecting structure, such as a pan, in which evaporative cooling elements are arranged, preferably covering all of the pan surface area, and most preferably extending out from the housing perimeter to capture water that might collect from any portion of the secondary cooling system or attachments. Water can pool on the evaporative cooling elements lining the pan, and physically extend to direct water from the collection points upwards and proximate housing vents (inside the housing, and/or outside the housing), and further proximate condenser coil fins to a position on the housing, or positioned on a frame near the housing, as near to the housing fan as practicable. While diffusion up may be limited with height, the liquid is moved upward by the diffusive effect of water being more forcefully drawn, or sucked by the fan. The fan's exhaust air flow captures water as low as the collecting pan, operating most strongly and most efficiently in an area in or proximate the housing that is closest to the fan, and its air sucking action. Leaving (evaporating) once-used water from the element portions closer to the fan draws other once-used water after it, up from lower levels, via capillary action and diffusion. Hence, the optimizer not only cools with the applied water in a first cooling cycle, but cools again with once-used collected water in a secondary water cooling cycle, by the ordinary fan action or operation.

A significant advantage to the inventive use lies in the energy savings derived by optimally cooling, and controlling compressor high-side pressures using only the electrical power to operate the solenoid in the water inlet valve to the optimizer. The secondary evaporative cooling has no added energy cost. The secondary evaporative cooling system is driven by gravity and diffusion to collect and recycle once-used water. This is accomplished by the housing fan as it operates normally. The housing fan captures and draws the once-used water in a fluid vapor combination from evaporative collector elements. The evaporative cooling elements are made of common material such as polyester, that will readily collect, hold and allow for liquid water diffusion, as well as readily releasing collected water for reuse with the evaporative action of the moving air from the fan. For that matter, the secondary evaporative cooling system allows for a reduction in water used for cooling by the primary water cooling system.

In a preferred embodiment, the secondary evaporative cooling system is enhanced with a small pump and water conduit (e.g., ¼″ plastic tubing), that pumps any pooling once-used water up and applies it to the upper portions of the evaporative cooling elements to better facilitate evaporative action by the fan. For that matter, the pump may be operated by a solar-driven power source, so as to obviate additional conventional power need at the compressor. The two-fold cooling action by the water, used once as a spray or mist by the primary water cooling system, and recycled and used twice by the optimizer secondary evaporative cooling system, leveraging the normal energy expanded by the fan, cools more efficiently and better reduces the operating load on the compressor, with advantages and benefits unknown in the prior art.

### BRIEF DESCRIPTION OF THE DRAWING FIGURES

In order that the manner in which the above recited and other advantages of the invention may be obtained, a more particular description of the invention briefly described above is rendered by reference to specific embodiments thereof that are illustrated in the appended drawings. Understanding that these drawings depict typical embodiments of the invention and are not therefore to be considered to be limiting of its scope, the invention is described and explained with additional specificity and detail through use of the accompanying drawings in which:

FIG. 1 is a system level diagram depicting a conventional air conditioning system;

FIG. 2 is a system level diagram depicting one embodiment of an air conditioning with optimizer of the invention; and

FIG. 3 is s system level diagram depicting an alternative embodiment of the optimizer depicted in FIG. 2.

### DETAILED DESCRIPTION OF THE INVENTION

An air conditioning system with optimizer that provides enhanced water cooling of intake air utilized to cool a compressor/condenser is described and set forth herein for the purpose of conveying broad inventive concepts of the system operation. The drawings and descriptions provided are not meant to limit the scope and spirit of the invention in any way.

The air conditioning system with optimizer cools the compressor with water, and collects and reapplies collected once used water and reapplies same in a secondary evaporative cooling cycle using normal fan operation. The compressor or compressor housing fan sucks air, the sucking air capturing water and water vapor first applied by the optimizer's primary water cooling system in a secondary optimizer evaporative cooling cycle. The secondary evaporative cooling system provides a collecting structure, such as a pan, in which the evaporative cooling elements extend, preferably covering all of the pan surface area. Preferably, evaporative cooling elements reside in the pan and extend out from the housing perimeter to capture water that might collect from any portion of the housing and its content, and the primary water cooling system structure and attachments. Water can pool in and on the evaporative cooling elements lining the pan, and move from collection points upwards and proximate housing vents (inside the housing, and/or outside the housing).

Portions of the evaporative cooling elements are arranged proximate condenser coil fins, extending up to and as near the fan as practicable within the housing, so that the fan's exhaust air sucking action captures any water and water vapor in the housing, and collection pan, drawing it up through the housing to again cool. The sucking is at a maximum closest to the fan. The once-used water, as it moves to leave the confines of the upper portion of the evaporative elements closest to the fan creates an up drawing of water in the evaporative cooling elements, against gravity, as in capillary action. The optimizer not only cools with the applied water in a first cooling cycle, but cools again with the collected water, controlling that the recycled water is again applied in the secondary water cooling cycle by the ordinary fan action or operation.

The secondary cooling system can be enhanced with a small pump and water conduit (e.g., ¼ plastic tubing) to pump collected once-used water up and apply it to the upper portions of the evaporative cooling elements. Pumping once-used water closer to the fan better facilitates evaporative action by the fan. For that matter, the pump may be operated by a solar-driven power source, so as to obviate additional conventional power needed at the compressor. The two-fold cooling action by the water, used once as a spray or mist, and recycled and used twice by the optimizer secondary evaporative cooling system, leverages the normal energy expanded by the fan, cooling more efficiently. Such cooling effect better reduces the operating load on the compressor, with advantages and benefits unknown in the prior art.

Operating a residential air conditioning unit modified with the optimizer with primary water and secondary evaporative cooling systems of the invention therefore reduces the electrical energy used to drive a compressor during intended operation, and minimizes an amount of water required to accomplish the cooling in view of the recycling. Most water is used at least twice, i.e., most water used in the primary water cooling is captured, recycled and reused by the secondary cooling system. First, the water is applied to the housing, condenser coil, condenser coil fins, etc., where some is evaporated and more collects in liquid form. Second, this used water is collected by the evaporative cooling elements of the secondary cooling system, and maintained in such a way that intended compressor fan operation recaptures the collected water and pulls it through the housing where its evaporation further cools the housing, fins, compressor, condenser, etc., situated therein.

The secondary cooling system takes advantage of energy used to drive the fan, so is energy conservant. The secondary evaporative cooling system not only provides the secondary cooling function, but implements water recapture and conservation of energy, thereby. The optimizer system and secondary cooling system are controlled by a pressure sensor connected to a high-side pressure fitting found between the compressor and condenser coil. The pressure sensor is set to respond to a fixed high-pressure point, or based on detected high-pressure differential of the refrigerant therein. At detection of a pressure equal to the detected set pressure point, or a pressure differential, the pressure sensor activates the optimizer system and secondary cooling system to optimize air conditioner system effectiveness, i.e., cooling operation, while minimizing compressor load and wear and conserving water use.

The secondary evaporative cooling system recaptures water misted and sprayed on the compressor, condenser coil and coil fins in the compressor housing using collectors in a form of base and housing mounted evaporative cooling elements. The base collectors are arranged to wrap around the housing base (which should be perforated at its lowest point), and the housing collectors are arranged to extend from the base collector under the housing, up and out from the first water collector on all sides external the housing to recapture water that may fall from the housing, fan, misting rack, frame, etc., during application by the primary water cooling system The evaporative cooling elements comprise flexible, water-impervious material, such as common polyester. Their actual size and coverage may be modified to best fit the dimensions of the compressor housing. Such secondary evaporative cooling system is not found in known residential and commercial air conditioning systems.

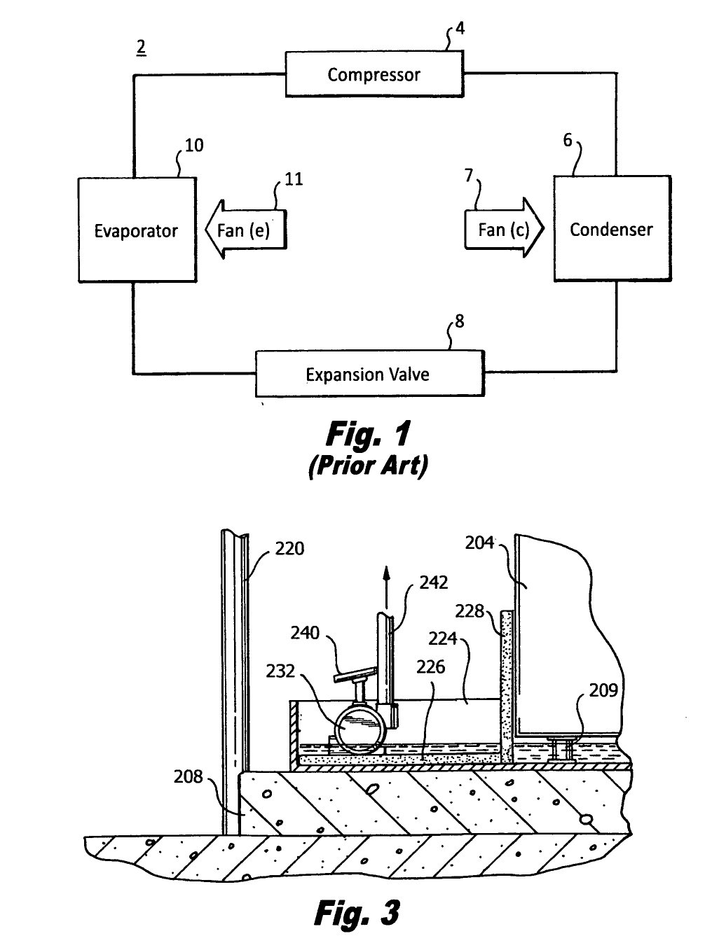

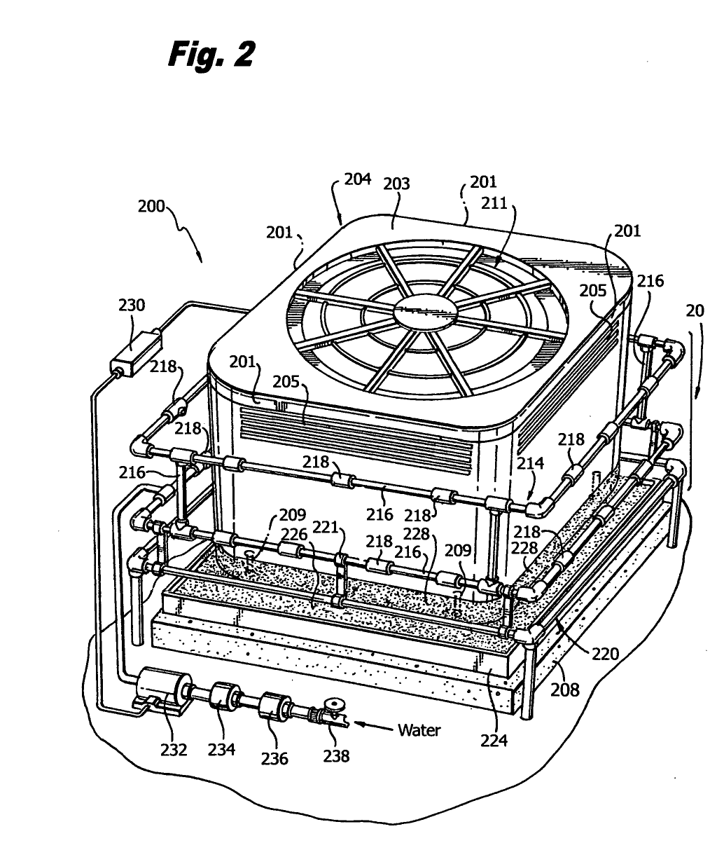

The air conditioning system with optimizer (200) is depicted in FIG. 2 to include a compressor housing (204), comprising walls (201) and a housing cover (203), compressor fan (211), and optimizer system (202). The compressor housing (204) includes baffles (205) in the housing walls to facilitate water and air cooling by the optimizer primary water cooling system, and for air intake to air cool the inner housing, and air conditioning system components housed therein, and to drive the secondary evaporative cooling system to implement the secondary reused evaporation process. The reader should note that while the baffles (205) are shown in only part of wall (201), the baffles comprise the entire housing (204). The housing encloses a compressor, condenser and coil fins (not shown in the drawing figure) which may be cooled by air and water communicated to the inner housing via the baffles (205). While not shown in FIG. 1, the air conditioning system comprising housing (204) operates with an expansion valve that is connected for fluid/gas communication to an evaporator. The evaporator provides heated cooling gas for compression and condensation to the compressor and condenser in the housing. The compressor housing (204) is best set in position on some type of solid base slab (208), the housing preferably raised a few inches, e.g., two, with standoffs (209).

The optimizer system (202) comprises a primary cooling system in a form of a water misting rack (214), constructed with a closed piping system (216) that includes water misting spray nozzles (218). The nozzles apply water for the optimizer system's primary water cooling operation. The misting rack (214) preferably further comprises a frame (220) to which the misting rack is adjustably attached and arranged about the housing for support by frame connectors (221). For that matter, the misting rack can be attached directly to the housing, obviating a need for the frame (220), without deviating from the scope and spirit of the invention.

A water catch and collecting pan (224) is arranged under the housing (204) to catch water that is applied for cooling the housing, compressor, condenser coil and condenser coil fins therein, by the misting rack. The standoffs (209) are shown in the water collecting pan (224), in the embodiment shown. The size of the pan may be varied, to meet particular physical limitations of the housing, and the space at which it is positioned. The water is sprayed or misted through the housing walls (201), via the baffles (205). Baffles (205) are shown only in part of one wall (201) for simplicity of drawing, and ease of explanation. The baffles (205) preferably are included in substantially all of the surface are of the housing walls (201) to facilitate air and fluid communication between the outside and inside of the compressor housing.

The optimizer system (202) further includes a secondary evaporative cooling system comprising base and housing wall evaporative cooling elements (226) and (228), respectively, and the collecting pan (224) as already described. The base evaporative cooling element or elements (226) are positioned in the collecting pan (224) to communicate water pooling therein to a flow of exhaust air generated by the fan. The housing wall evaporative cooling element (228) sits upon, or is contiguous with base element (226) in collecting pan (224). The base (226) and housing wall (228) evaporative cooling elements direct collected, once-used water towards the fan, so that the water is subjected to the sucking effect of the exhausting air. The base evaporative cooling element (226) may wrap around and extend out from the housing base, where the housing wall evaporative cooling element extends up from the base. The housing base should be perforated at its lowest point to capture water that may fall from the housing, fan, misting rack, frame, etc., during operation of the primary water cooling system.

The evaporative base and housing wall evaporative cooling elements (226; 228) comprise flexible, water capturing and water releasing material, such as common polyester or materials used in conventional swamp coolers, e.g., Dacron™. The actual size and water-capture coverage of the evaporative cooling elements may be modified to best fit the dimensions of the compressor housing. Both the base and wall evaporative cooling elements capture and release to secondary evaporative action water that is first misted or sprayed on and into the compressor housing and elements therein by the optimizer system's primary water system, as described. Preferably, the evaporative cooling elements cover the entire collecting pan surface area and extend out from a housing perimeter to capture water that might collect from any air conditioner surface.

In an alternative embodiment, wall evaporative cooling element (228) can extend up to about ten inches below the top of the housing, proximate fan (211). In such an embodiment, the misting rack (214), piping system (216) and spray nozzles (218) are connected directly to the housing by connecting means in such a manner that the nozzles spray down towards the housing walls (210) and fan (211). Preferably, the nozzles spray on the housing, or baffles, and do not spray directly on the evaporative cooling elements.

The misting rack (214) and primary water cooling system further comprises a water valve (232) for controlling a flow of water to the misting rack (214), the piping system (216) and nozzles (218). While the primary water cooling system can support any number of nozzles, the embodiment shown includes 26 nozzles. During air conditioner system (200) and optimizer system (202) operation, a thermostat (not shown) in an area to be cooled signals to a system controller (not shown) that cooling action is required. The system controller coordinates the operation of the compressor and condenser, including the fan (211). An optimizer controller (230) connects to a t-valve (not shown) interposed in the refrigerant line at a high-side pressure, within the housing. A signal from the t-valve is processed by the controller based on the pressure, or a differential pressure found at the compressor, and thereby automatically signals the optimizer to operate as intended.

That is, the pressure controller senses that a high side gas pressure on the compressor exceeds a present threshold, and sends a signal that closes a normally open contact in controller (230). The contact activates a water valve (232) permitting circulation of the water comprising the optimizer system and misting through the nozzles, as described above. The water valve (232) is controlled by the controller, which provides a signal based on pressure, and is fed by a flow from a water supply or spigot (238), via a water conditioner (236) and filter (234). Preferably, the water valve (232) includes a solenoid that is 24 VAC activated. The filter is preferably de-scaling, and sediment removing and the conditioner is preferably a high-intensity magnetic water conditioner. Nominally, the primary cooling water is circulated and released through the nozzles at around 120 PSI, but may be adjusted to operate under less than ideal water pressures, e.g., 90 PSI or less. The cooling effect of the sprayed or misted water results in a commensurate drop in pressure in accordance with PV=nRT, as known. Hence, the optimizer system operates at a reduced pressure, even in the most severe ambient environments.

The secondary evaporative cooling system is constructed to recapture the water used by the primary optimizer cooling system, recycling it back for reapplication during secondary cooling operation. As the mist water condenses on the condenser coil fins and housing (i.e., frame). The condensed water is inhaled by the condenser fan back over the fins as water a vapor. As the mist is applied to the condenser cooling fins, there is an almost immediate reduction in temperature, and reduction in high side pressure, up to at least 30%. This drop in gas pressure removes substantial load from the work being done by the compressor, electrically. For example, use of the optimizer could reduce compressor current draw from 30 amps to 20 amps in consequence of the optimizer cooling action. After a varying time, the differential setting of the pressure control switch senses the reduced high side gas pressure, and opens the contact to the water valve. This stops the flow of water to the optimizer, i.e., misting rack. Cooling operation continues until ceased by a signal from the thermostat.

While the limited energy cost for circulating the water in the first cooling system is valuable in improving air conditioner system operation broadly, the second use of recovered water as a secondary cooling is valuable not only because it is energy cost free, taking advantage of the fans sucking power during its normal operation, but that it is water conservant. This is particularly useful in environments where temperatures normally exceed 95 degrees Fahrenheit, and exhibit normally low humidity and/or low atmospheric pressure, for example, arid regions above 500 feet. Even at 95 degrees Fahrenheit, and approximately 0% humidity, where the optimizer (202) is operated half of the time, waste water loss is maintained at about 20% using the optimizer system and secondary evaporative cooling system with water recapture.

FIG. 3 highlights a preferred embodiment of the secondary cooling system in that the base evaporative cooling element (226) includes a small secondary pump (232) and water conduit (242), e.g., ¼″ plastic tubing, to pump collected once-used water up and apply it to the upper portions of the evaporative cooling elements. Pumping once-used water closer to the fan better facilitates evaporative action by the fan, further enhancing the cooling effect of the secondary cooling cycle. The secondary pump is preferably a ½″, ¾ Amp pump, capable of outputting 1/50 HP. For that matter, the secondary pump may be operated by a solar-driven power source (240), so as to obviate additional conventional power need at the compressor. The two-fold cooling action by the water, used once as a spray or mist, and recycled and used twice by the optimizer secondary cooling system, leveraging the normal energy expanded by the fan, cools more efficiently and better reduces the operating load on the compressor, with advantages and benefits unknown in the prior art.

Although a few examples of the present invention are shown and described, it would be appreciated by those skilled in the art that changes may be made in these embodiments without departing from the principles and spirit of the invention, the scope of which is defined in the claims and their equivalents.

What is claimed is:

1. An air conditioning system with optimizer for optimizing compressor operation including modifying a temperature and pressure of refrigeration fluid and/or gas operating for cooling purposes in a compressor or condenser coil within a compressor housing using enhanced water cooling by and with an exhaust air flow generated by a compressor housing fan, the optimizer comprising:
a primary water cooling system that applies cooling water to the compressor through the compressor housing in a primary water cooling cycle; and
a secondary evaporative cooling system that operates with the primary water cooling system to capture once-used water in evaporative cooling elements that direct the once-used water to compressor housing locations susceptible to the exhaust air flow during normal air conditioning system operation, the exhaust air flow operating with the evaporative cooling elements to evaporate the once-used water in a secondary evaporative cooling cycle, and controlling temperature and refrigeration fluid pressure to minimize compressor load in an energy-conserving and water-conserving manner.

2. The air conditioning system with optimizer defined in claim 1, wherein the optimizer includes a controller for driving the primary water cooling system and the secondary evaporative cooling system by detecting one or both of a preset temperature and refrigeration fluid pressure during normal compressor operation.

3. The air conditioner system with optimizer set forth in claim 2, wherein the controller includes a pressure sensor at the compressor, by detecting a pressure of the refrigeration fluid, and a switch for controlling operation of the primary water cooling system.

4. The air conditioner system with optimizer set forth in claim 2, wherein the controller comprises a pressure control switch that senses when a high-side gas pressure on the compressor exceeds a threshold value and switches on the primary water cooling system.

5. The air conditioner system with optimizer set forth in claim 4, wherein the primary water cooling system comprising water flow conduits for carrying cooling water, and water nozzles arranged to apply the cooling water to the compressor.

6. The air conditioner system with optimizer set forth in claim 5, wherein the primary water cooling system further comprises a water flow valve electrically connected to the pressure control switch, which responds to a pressure detected to exceed the threshold value thereby activating the water flow valve.

7. The air conditioner system with optimizer set forth in claim 4, wherein the secondary evaporative cooling system comprises evaporative cooling elements arranged to capture water once-used by the primary cooling system to water cool the compressor, and extending up onto the compressor housing proximate the compressor fan and exhaust air flow in order to capture the once-used water and evaporate the captured water in a secondary cooling cycle fan during normal compressor operation.

8. The air conditioner system with optimizer set forth in claim 5, wherein the secondary evaporative cooling system includes a once-used water collecting pan within which at least a portion of the evaporative cooling elements are arranged to capture once-used water.

9. The air conditioner system with optimizer set forth in claim 7, wherein the evaporative cooling elements extend from the once-used water collecting pan to a position on the compressor housing proximate the fan and or the exhaust air flow, and wherein the primary water cooling system comprises a water conduit system with water spray nozzles that is connected to the compressor housing proximate the fan such that the water spray nozzles spray water downwards into the housing when the primary water cooling system is activated.

10. The air conditioner system with optimizer set forth in claim 8, wherein the secondary evaporative cooling system includes a water pump and fluid flow conduit that pumps pooled, collected once-used water up towards the fan, and deposits the once-used water on evaporative cooling element portions that are arranged as close to the fan, and exhaust air flow.

11. The air conditioner system with optimizer set forth in claim 10, wherein the water pump comprises a ½ inch, ¾ amp pump with a 1/50 hp output.

12. The air conditioner system with optimizer set forth in claim 10, wherein the water pump is a solar-powered pump.

13. An optimizer system constructed for operation with an air conditioner system that includes a compressor housing in which are disposed a compressor, compressor fan and a condenser coil including a refrigeration fluid therein for heat exchange, and for optimizing compressor operating conditions by modifying compressor high-side compressor pressure by spraying and/or misting water on the compressor and compressor housing in a primary water cooling cycle, and operating a secondary evaporative cooling cycle that collects cooling water once-used in the primary cooling and directs the collected once-used water proximate the compressor fan for capture by an exhaust air flow out of the compressor housing during normal fan operation,
the secondary evaporative cooling system further comprising evaporative water capture cooling elements to collect the water used once in the primary water cooling cycle and direct the once-used water to locations within the compressor housing that expose the once-used water to the exhaust air flow further cooling the compressor minimizing compressor load in an energy and water conserving manner.

14. The optimizer system constructed for operation with an air conditioner system set forth in claim 13, wherein the primary water cooling system comprises:
a misting rack of water pipe arranged to surround the compressor housing and including spray nozzles within a water flow maintained by the water pipe;
a water valve connected to a water supply and the misting rack that is activated and deactivated during intended air conditioner system operation in response to a signal to enable the primary water cooling system and misting rack; and
a controller that senses a need for optimizer cooling and activates the water flow valve.

15. The optimizer system constructed for operation with an air conditioning system set forth in claim 14, wherein the controller comprises a pressure control switch connected to the compressor to sense high-side pressure.

16. The optimizer system constructed for operation with an air conditioner system set forth in claim 14, wherein the primary water cooling system further comprises a frame to support the misting rack.

17. The optimizer system constructed for operation with an air conditioner system set forth in claim 14, wherein the secondary evaporative cooling system comprises evaporative cooling elements that are arranged about and upon the housing to collect water applied once by the primary water cooling system, and communicate the applied once water for capture by exhaust air flow generated by the fan.

18. The optimizer system constructed for operation with an air conditioner system set forth in claim 17, wherein the secondary evaporative cooling system further comprises a collecting pan constructed to be inserted under the compressor housing, and for receiving a collecting portion of the evaporative cooling elements.

19. The optimizer system constructed for operation with an air conditioner system set forth in claim 17, wherein the misting rack is connected directly to the compressor housing at a position proximate the compressor fan such that the spray nozzles spray water downwardly towards and into the compressor housing.

20. The optimizer system constructed for operation with an air conditioner system set forth in claim 18, wherein the secondary evaporative cooling system includes a secondary pump, and water conduit system constructed to extend from the collecting pan to pump once-used water to the portion of the evaporative cooling elements proximate the compressor fan and exhaust air flow.
